(19) United States
(12) Patent Application Publication
(10) Pub. No.: US 2026/0073797 A1
(43) Pub. Date: Mar. 12, 2026

(54) AUTOMATIC COMMUNICATION METHOD AND SYSTEM FOR AN AIRCRAFT

(71) Applicant: Airbus (S.A.S.), Blagnac Cedex (FR)

(72) Inventors: Thomas Pastre, Toulouse (FR); Laura Fersing, Toulouse (FR); François Lancelot, Toulouse (FR); Anaïs Mermet, Toulouse (FR)

(21) Appl. No.: 18/748,502

(22) Filed: Jun. 20, 2024

(30) Foreign Application Priority Data
Jun. 23, 2023 (FR) FR2306603

(51) Int. Cl. G08G 5/32; G08G 5/26; G10L 13/00; H04W 76/50

(52) U.S. Cl. CPC G08G 5/32; G08G 5/26; G10L 13/00; H04W 76/50

(57) ABSTRACT

A communication method for an aircraft with an air traffic control center includes receiving information relating to the activation of guidance of the aircraft along a contingency trajectory, sending a first message on a first communication frequency, to inform air traffic control of the activation of guidance of the aircraft along the contingency trajectory, and of the sending of further messages on a second communication frequency used for emergency communications, sending a second message on the second communication frequency, to inform air traffic control of the activation of guidance of the aircraft along the contingency trajectory, and sending a set of messages on the second communication frequency, to inform air traffic control of maneuvers that the aircraft is going to implement.

### TECHNICAL FIELD

The disclosure herein relates to the field of aircraft communications with air traffic control.

### BACKGROUND

In a situation in which a pilot of the aircraft is incapacitated, thereby preventing the pilot from controlling the aircraft, in particular where the aircraft has just one pilot, it is known to automatically determine (using an avionics system of the aircraft) a contingency trajectory enabling the aircraft to be brought to a diversion airport and to automatically guide the aircraft along this contingency trajectory. Document FR3121208A1 describes a method and a system for generating such a contingency trajectory to a runway of a diversion airport.

If a pilot is controlling the aircraft, he communicates with air traffic control in particular to communicate a flight plan for the aircraft and modifications to the flight plan. If the pilot is incapacitated, he can no longer communicate with air traffic control, even though it is important to inform air traffic control of the change of trajectory of the aircraft to ensure the safety of the flight in relation to nearby traffic. There is therefore a need for a solution enabling air traffic control to be informed of such a situation.

### SUMMARY

The disclosure herein is notably intended to provide a solution to this problem. The disclosure herein relates to an automatic communication method for an aircraft with at least one air traffic control center. The method is noteworthy in that it comprises the following steps implemented automatically by electronic circuitry on board the aircraft:
a first step consisting of receiving information relating to the activation of automatic guidance of the aircraft along a contingency trajectory in a situation in which a pilot of the aircraft is incapacitated, the contingency trajectory corresponding to a trajectory determined automatically by an avionics system of the aircraft in response to detection of the situation in which the pilot is incapacitated;
a second step consisting of preparing then sending at least a first message on a first communication frequency selected before the activation of guidance of the aircraft along the contingency trajectory, this at least one first message being intended to inform air traffic control on one hand of the activation of automatic guidance of the aircraft along the contingency trajectory, and on the other hand of the sending of further messages on a second communication frequency used for emergency communications;
a third step consisting of preparing then sending at least one second message on the second communication frequency, this second message being intended to inform air traffic control of the activation of automatic guidance of the aircraft along the contingency trajectory;
a fourth step, while the aircraft is flying along the contingency trajectory, consisting of receiving information relating to maneuvers that the aircraft will implement to follow the contingency trajectory, and preparing then sending a set of messages on the second communication frequency, the messages of the set of messages being intended to inform air traffic control of maneuvers that the aircraft will implement.

Thus, the method according to the disclosure herein enables air traffic control to be informed of activation of the contingency trajectory and of different maneuvers of the aircraft that are going to be implemented. Sending the at least one first message on the first frequency selected before the pilot was incapacitated, then subsequent messages on the second frequency used for emergency communications firstly helps to attract the attention of an air traffic controller to the situation of the aircraft and the need to listen to the communications on the second frequency, then to communicate more securely on the second frequency, which is less occupied with communications from other aircraft since it is reserved for emergencies.

According to various embodiments, which may be taken in isolation or in combination:
the different messages sent to the air traffic control center are audio messages produced by speech synthesis;
the method includes a step, before the second step, during which a transponder code of the aircraft used for communication with air traffic control is replaced by a transponder code specific to emergency situations;
the second step comprises a first sub-step of preparing then sending a first initial message that is intended to inform air traffic control of the activation of automatic guidance of the aircraft along the contingency trajectory, as well as a second sub-step implemented after a first predetermined time after the first sub-step, of sending a first subsequent message that is intended on one hand to remind air traffic control of the activation of automatic guidance of the aircraft along the contingency trajectory, and on the other hand to inform air traffic control of the sending of further messages on the second communication frequency used for emergency communications;
the third step comprises a first sub-step of preparing then sending a second initial message that is intended to inform air traffic control of the activation of automatic guidance of the aircraft along the contingency trajectory, as well as a second sub-step implemented after a second predetermined time after the first sub-step, of preparing then sending a second subsequent message that is intended to give air traffic control information relating to the contingency trajectory;
the fourth step further comprises sending additional messages on the second frequency, these additional messages being sent at a predefined time period if a time interval between two consecutive messages of the set of messages is greater than the period;
the fourth step further comprises sending messages relating to events occurring during the flight of the aircraft along the contingency trajectory;
when the aircraft is flying along a part of the contingency trajectory corresponding to an airport runway approach, the fourth step further comprises sending different messages on a frequency specific to this approach.

The disclosure herein also relates to a communication system carried on board an aircraft, this system comprising electronic circuitry provided to implement a communication method as set out above.

The disclosure herein also relates to an aircraft comprising such a communication system.

### BRIEF DESCRIPTION OF THE DRAWINGS

The disclosure herein will be better understood upon reading the following description and upon studying the appended figures.

FIG. 1 shows an aircraft comprising a communication system.

FIG. 2 schematically illustrates a communication system for an aircraft according to one embodiment of the disclosure herein.

FIG. 3 illustrates a communication method for an aircraft according to one embodiment of the disclosure herein.

FIG. 4 illustrates the sending of radio communication messages within the context of the method in FIG. 3 on two communication frequencies F1 and F2 as a function of time t.

FIG. 5 illustrates example content of messages (in English according to aeronautical procedures) that could be sent by the communication system.

### DETAILED DESCRIPTION

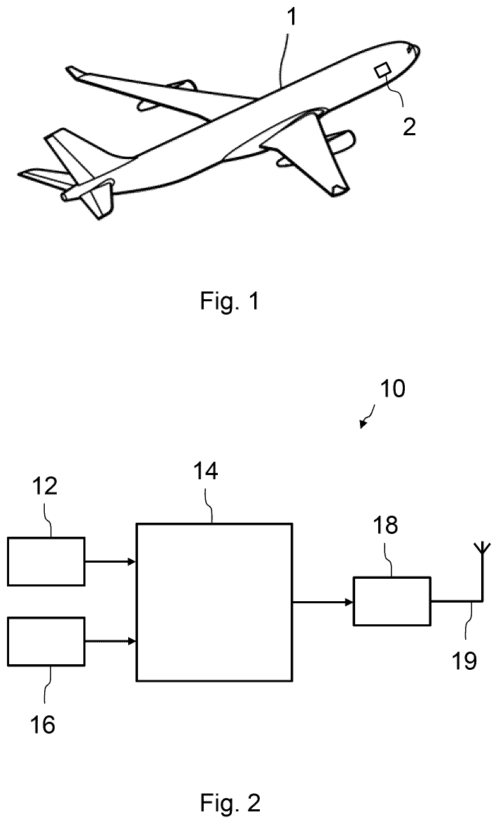

The aircraft 1 shown in FIG. 1 comprises a communication system 10 as shown in FIG. 2. The communication system 10 comprises electronic circuitry 14 connected at input to a first information source 12 as well as to a second information source 16. The electronic circuitry 14 is also connected at output to a radio communication device 18, for example a very-high frequency (VHF) device, connected to an antenna 19. According to one embodiment, the electronic circuitry 14 is an avionics computer of the aircraft. According to another embodiment, the electronic circuitry 14 is an FPGA programmable logic circuit. The communication system 10 is for example installed in an avionics bay 2 of the aircraft 1.

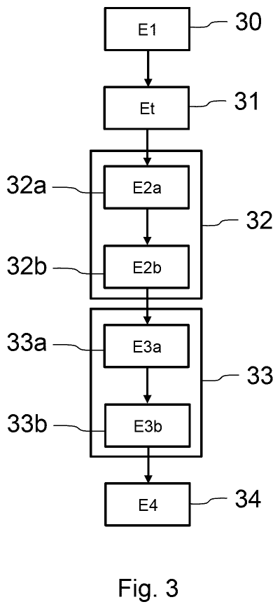

The electronic circuitry 14 is configured to implement the communication method illustrated in FIG. 3.

A first step 30 of the method, labelled E1 in the figure, involves receiving information relating to the activation of automatic guidance of the aircraft along a contingency trajectory in a situation in which a pilot of the aircraft is incapacitated. The electronic circuitry 14 receives this information from the first information source 12. The first information source is for example a guidance computer of the aircraft, a flight management computer of the aircraft, or an avionics computer configured to detect and manage a situation in which a pilot of the aircraft is incapacitated. In particular, this avionics computer is configured to automatically determine the contingency trajectory in response to detection of a situation in which the pilot of the aircraft is incapacitated. The contingency trajectory is provided to enable the aircraft to land on a runway of a diversion airport.

Following receipt of the information, in a second step 32 of the method, the electronic circuitry 14 prepares at least a first message then orders the radio communication device 18 to send the at least one first message on a first communication frequency F1 selected before the activation of automatic guidance of the aircraft along the contingency trajectory. This at least one first message is intended to inform air traffic control on one hand of the activation of guidance of the aircraft along the contingency trajectory, and on the other hand of the sending of further messages on a second communication frequency F2 used for emergency communications. The first communication frequency F1 is notably a frequency already used by the pilot before he was incapacitated to communicate with air traffic control. It is therefore a frequency on which air traffic control and nearby aircraft expect to receive communications from the aircraft 1. Thus, the first message informs air traffic control and nearby aircraft of the emergency situation of the aircraft.

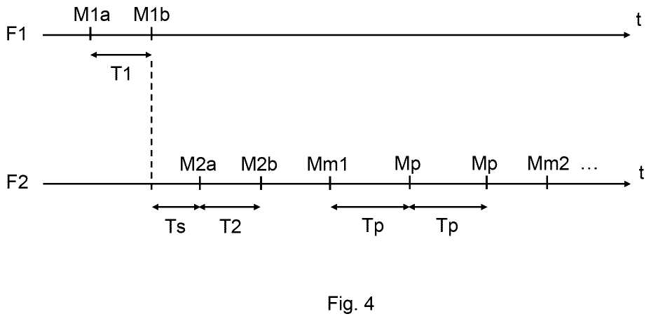

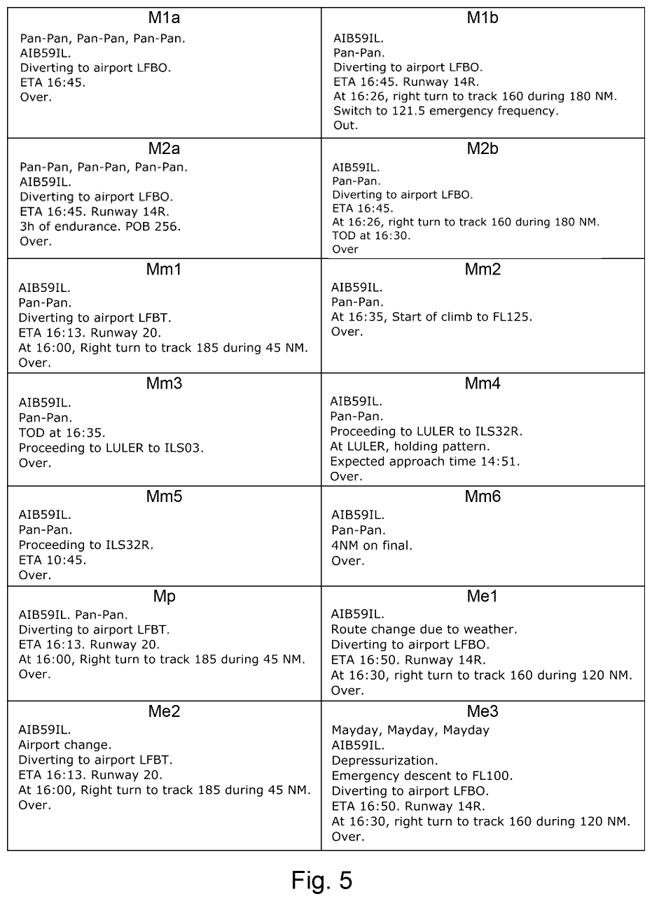

In one specific embodiment, the second step 32 comprises a first sub-step 32a, labelled E2a in the figure, during which the electronic circuitry 14 prepares a first initial message M1a then orders the radio communication device 18 to send the first initial message M1a, the first initial message M1a being intended to inform air traffic control of the activation of guidance of the aircraft along the contingency trajectory. The second step 32 further comprises a second sub-step 32b, labelled E2b in the figure and implemented after a first predetermined time T1 after the first sub-step 32a. This first time T1 is for example 30 seconds. During the second sub-step 32b, the electronic circuitry 14 orders the radio communication device 18 to send a first subsequent message M1b that is intended on one hand to remind air traffic control of the activation of guidance of the aircraft along the contingency trajectory and to give synthetic information on the contingency trajectory, and on the other hand to inform air traffic control of the sending of further messages on the second communication frequency F2 used for emergency communications. Thus, the first initial message helps to attract the listeners'attention to the emergency situation of the aircraft so that they are more attentive when they receive the first subsequent message. Advantageously, the first subsequent message repeats content similar to the content of the first initial message, with the addition of synthetic information on the contingency trajectory. The content of the messages M1a and M1b is for example as illustrated in FIG. 5. The sending chronology of the messages M1a and M1b on the first frequency F1 is illustrated in FIG. 4.

Following the sending of the first message during the second step 32, in a third step 33 of the method, the electronic circuitry 14 prepares at least one second message then orders the radio communication device 18 to send the at least one second message on a second communication frequency F2 used for emergency communications. This at least one second message is intended to inform air traffic control of the activation of guidance of the aircraft along the contingency trajectory. The second communication frequency F2 used for emergency communications is for example a frequency of 121.5 MHz. Sending the at least one second message initiates communication with air traffic control on this second communication frequency F2, resending the information already sent on the first communication frequency F1. Thus, if these two frequencies are being listened to by two separate air traffic controllers, the air traffic controller listening to the second communication frequency F2 has all of the information sent automatically by the aircraft 1.

In one specific embodiment, the third step 33 comprises a first sub-step 33a, labelled E3a in the figure, during which the electronic circuitry 14 prepares a second initial message M2a then orders the radio communication device 18 to send the second initial message M2a, the second initial message M2a being intended to inform air traffic control of the activation of guidance of the aircraft along the contingency trajectory. The first sub-step 33a is implemented after a predetermined time Ts after the end of the second step 32. This time Ts is for example 60 seconds. The third step 33 further comprises a second sub-step 33b, labelled E3b in the figure and implemented after a second predetermined time T2 after the first sub-step 33a. This second time T2 is for example 30 seconds. During the second sub-step 33b, the electronic circuitry 14 orders the radio communication device 18 to send a second subsequent message M2b that is intended to provide air traffic control with information relating to the contingency trajectory. The content of the messages M2a and M2b is for example as illustrated in FIG. 5.

After sending the at least one second message, in a fourth step 34, labelled E4 in the figure, when the aircraft is flying along the contingency trajectory, the electronic circuitry 14 receives information from the second information source 16 relating to maneuvers that the aircraft will implement to follow the contingency trajectory: for example a turn, a start of climb, a start of descent, etc. Following the receipt of information relating to one of the maneuvers, the electronic circuitry prepares a message Mm1, Mm2. . . then orders the radio communication device 18 to send, on the second communication frequency F2, the message Mm1, Mm2. . ., the message Mm1, Mm2. . . being intended to inform air traffic control of the manoeuvre that the aircraft is going to implement. Thus, when the aircraft is flying along the contingency trajectory, the aircraft sends a set of messages on the second communication frequency, the messages of the set of messages being intended to inform air traffic control of maneuvers that the aircraft is going to implement. FIG. 5 illustrates example content of such messages Mm1, Mm2. . . Mm6. The second information source 16 is for example a guidance computer of the aircraft, a flight management computer of the aircraft, or an avionics computer configured to detect and manage a situation in which a pilot of the aircraft is incapacitated. According to a first alternative, the first information source 12 and the second information source 16 are separate. According to a second alternative, the first information source 12 and the second information source 16 are one and the same computer of the aircraft. According to another alternative, the first information source 12, the second information source 16 and the electronic circuitry 14 are one and the same computer of the aircraft, for example an avionics computer configured to detect and manage a situation in which a pilot of the aircraft is incapacitated.

Advantageously, the fourth step further comprises sending additional messages Mp on the second communication frequency F2. These additional messages are sent at a predefined time period Tp if a time interval between two consecutive messages, for example Mm1 and Mm2, of the set of messages is greater than the period Tp. The period Tp is for example 7 minutes. These additional messages are intended to maintain contact with air traffic control with a time period at least equal to the period Tp.

In one specific embodiment, during the fourth step, when the electronic circuitry 14 receives information from the second information source 16 relating to an event that occurred during the flight of the aircraft along the contingency trajectory, the electronic circuitry 14 orders the radio communication device 18 to send a message relating to this event on the second communication frequency F2 to inform air traffic control of the event. The event in question is an event relating to the aircraft or to the trajectory thereof, for example depressurization, a fault, a change in weather conditions resulting in a change of trajectory, etc. FIG. 5 illustrates example content of messages Me1, Me2, Me3 relating to events.

In one embodiment, when the aircraft is flying along a part of the contingency trajectory corresponding to an airport runway approach, in addition to sending different messages on the second communication frequency F2, the fourth step comprises sending the different messages on a frequency specific to this approach. This enables these messages to be sent to an air traffic controller in charge of aircraft landing from this approach. This is particularly advantageous if this air traffic controller is not listening to the second communication frequency F2 used for emergency communications. Specifically, the part of the contingency trajectory corresponding to the runway approach starts at a starting point of the descent of the aircraft to the runway, generally referred to as top of descent (TOD).

In one advantageous embodiment, the method further comprises a step 31, labelled Et in FIG. 3, implemented after the first step 30 and before the second step 32, during which a transponder code of the aircraft used for communication with air traffic control is replaced by a transponder code specific to emergency situations. This specific transponder code is for example the code 7700. This helps to further attract the attention of air traffic control to the emergency situation of the aircraft.

Advantageously, the different messages sent by the communication system to air traffic control are prepared in text form by the electronic circuitry, then transformed into voice messages by speech synthesis before being sent on the first or the second communication frequency. These messages are prepared in real time by the electronic circuitry 14 as a function of the operational conditions of the aircraft.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An automatic communication method for an aircraft with at least one air traffic control center, the method comprising steps implemented automatically by electronic circuitry on board the aircraft of:
a first step of receiving information relating to activation of automatic guidance of the aircraft along a contingency trajectory in a situation in which a pilot of the aircraft is incapacitated, the contingency trajectory corresponding to a trajectory determined automatically by an avionics system of the aircraft in response to detection of the situation in which the pilot is incapacitated;
a second step of preparing then sending at least a first message on a first communication frequency selected before the activation of guidance of the aircraft along the contingency trajectory, the at least one first message to inform air traffic control of the activation of automatic guidance of the aircraft along the contingency trajectory, and of the sending of a further message or messages on a second communication frequency used for emergency communications;
a third step of preparing then sending at least one second message on the second communication frequency, the second message to inform air traffic control of the activation of automatic guidance of the aircraft along the contingency trajectory; and
a fourth step, while the aircraft is flying along the contingency trajectory, of receiving information relating to maneuvers that the aircraft will implement to follow the contingency trajectory, and preparing then sending a set of messages on the second communication frequency, the messages of the set of messages to inform air traffic control of maneuvers that the aircraft will implement.

2. The method according to claim 1, wherein the messages sent to the air traffic control center are audio messages produced by speech synthesis.

3. The method according to claim 1, comprising a step, before the second step, during which a transponder code of the aircraft used for communication with air traffic control is replaced by a transponder code specific to emergency situations.

4. The method according to claim 1, wherein the second step comprises a first sub-step of preparing then sending a first initial message to inform air traffic control of the activation of automatic guidance of the aircraft along the contingency trajectory, as well as a second sub-step implemented after a first predetermined time after the first sub-step, of sending a first subsequent message to remind air traffic control of the activation of automatic guidance of the aircraft along the contingency trajectory, and to inform air traffic control of the sending of a further message or messages on the second communication frequency used for emergency communications.

5. The method according to claim 1, wherein the third step comprises a first sub-step of preparing then sending a second initial message to inform air traffic control of the activation of automatic guidance of the aircraft along the contingency trajectory, as well as a second sub-step implemented after a second predetermined time after the first sub-step, of preparing then sending a second subsequent message to give air traffic control information relating to the contingency trajectory.

6. The method according to claim 1, wherein the fourth step comprises sending additional messages on the second frequency, these additional messages being sent at a predefined time period if a time interval between two consecutive messages of the set of messages is greater than the time period.

7. The method according to claim 1, wherein the fourth step comprises sending messages relating to events occurring during a flight of the aircraft along the contingency trajectory.

8. The method according to claim 1, wherein, when the aircraft is flying along a part of the contingency trajectory corresponding to an airport runway approach, the fourth step comprises sending different messages on a frequency specific to the approach.

9. A communication system carried on board an aircraft comprising electronic circuitry provided to implement the communication method according to claim 1.

10. An aircraft comprising the communication system according to claim 9.
